(19) United States
(12) Patent Application Publication
(10) Pub. No.: US 2018/0111555 A1
(43) Pub. Date: Apr. 26, 2018

(54) AUTO-ADJUSTABLE DISPLAY MOUNT

(71) Applicants: Junfeng Men, PLYMOUTH, MI (US); Liang Yang, PLYMOUTH, MI (US); Hao Cheng, LIVONIA, MI (US)

(72) Inventors: Junfeng Men, PLYMOUTH, MI (US); Liang Yang, PLYMOUTH, MI (US); Hao Cheng, LIVONIA, MI (US)

(21) Appl. No.: 15/333,213

(22) Filed: Oct. 25, 2016

(51) Int. Cl. B60R 1/02; F16M 11/20; F16M 11/10; F16M 13/02; F16M 11/18; H02K 7/116; H02K 21/12

(52) U.S. Cl. CPC B60R 1/025; F16M 11/2014; F16M 11/10; H02K 21/12; F16M 11/18; H02K 7/1166; F16M 13/02

(57) ABSTRACT

The present invention is an auto-adjustable display mount. The present invention can be used in a system that auto-adjusts the position and angle of a display based on the identity of the user, the position of the user, the type of display, the environment, and the application. The present invention is comprised of two adjustment modules, connected to a bracket with which to retain a display. The two adjustment modules are comprised of a housing, a brushless direct current motor, a worm gear, and a rotational axle. The two adjustment modules are connected, with the lower adjustment module connected to the rotational axle of the upper adjustment module. Each adjustment module is capable of rotating through at least 120°.

### FIELD OF INVENTION

This invention relates to the classification of supports, and to one or more sub-classifications for mirror or picture type supports. Specifically, this invention is an auto-adjustable display mount for use in a system that auto-adjusts the location and angle of a display, such as the internal rearview mirror of a vehicle.

### BACKGROUND OF INVENTION

It is a legal requirement in most jurisdictions that a rearview mirror be installed in the passenger compartment of a motor vehicle. For example, over the years, the United States National Highway Transportation Safety Administration (“NHTSA”) has been tasked by Congress with creating, and revising, numerous standards related rearview mirrors. These standards are mostly enumerated in the Consolidated Federal Register (“CFR”) as part of the Federal Motor Vehicle Safety Standards (“FMVSS”). Currently, these standards are found in FMVSS No. 111, as expressed at 49 CFR 571.111, in a document entitled, “Standard No. 111; Rearview mirrors.”

The purpose of this standard is to reduce the number of deaths and injuries that occur when the driver of a motor vehicle does not have a clear and reasonably unobstructed view to the rear of the vehicle. FMVSS No. 111 requires that each passenger vehicle to have an interior rearview mirror with a unit magnification. The interior rearview mirror must provide the driver with a field of view, when not obstructed by headrests or passengers, with an included horizontal angle measured from the projected eye point of at least 20 degrees, and a sufficient vertical angle to provide a view of a level road surface extending to the horizon beginning at a point not greater than 61 m to the rear of the vehicle. The projected eye point, a reference point representing the driver's eye location, is defined in FMVSS No. 104.

The FMVSS represents a functionality baseline, which a vehicle manufacturer can meet in its own chosen way. Among the problems faced by vehicle manufacturers when trying to meet FMVSS No. 111 are variations in driver height; variations in light; the use of electro-chromatic mirrors; the position of the driver's seat; the positioning of the driver; and rear seat obstructions, inter alfa. Embedding displays in rearview mirrors, or fabricating the entire rearview apparatus from a display rather than a reflective surface is increasingly common. In fact, as technology advances, displays may totally supplant mirrors for rearview applications. However, displays come with their own problems. Many displays are polarized, meaning that drivers with polarized sunglasses can only view the display from certain angles. Additionally, display visibility can be greatly affected by reflections and glare.

Manufacturers must account for different drivers using the same vehicle. This is not only a problem with multi-driver households. It is a problem of new technology: the use of car-sharing services, such as Zipcar®, FlightCar, Turo, and GetAround, is rapidly growing. Additionally, traditional car rental companies, such as Enterprise, are now offering micro-rentals.

Current internal rearview mirrors mostly consist of a reflecting surface supported in a frame. The frame is capable of swiveling about an articulating joint, to allow the mirror to be adjusted. Some mirrors use electro-chromatic technology to adjust the reflecting surface depending on the amount of sunlight. Other mirrors require the user to adjust the mirror to a different use position for day and night driving.

The problems encountered with rearview mirrors are also experienced by users of tablets or mobile phones when they are in a vehicle or other changeable environments. Drivers of commercial vehicles, drivers driving for a ride-sharing service, and drivers using their cellphones or tablets as a navigational aid all have a need for an in-vehicle display mount. Sunlight glare, user position, the brightness of the day, the application, and the use of polarized sunglasses can all affect the viewing of tablets and mobile phones.

What is needed is an auto-adjustable display mount that can adjust an internal rearview mirror, or other display, in order to optimize the visibility of the mounted device. A rearview mirror with an auto-adjustable mount, constructed in the manner disclosed herein, allows mirrors and displays to adjust for different users, different environments, and different use conditions or applications.

### PRIOR ART REVIEW

There is clearly a market demand for an auto-adjustable display mount. The recent prior art for internal and external mirrors teaches many useful concepts, but nothing that is identical to the present invention. Several patents use multiple motors and worm gears to adjust a mirror reflecting surface. For example, U.S. Utility Pat. No. 9,242,607, by named inventors Sobecki et. al., entitled, “Exterior mirror assembly with actuator” (“Sobecki '607”) and U.S. Utility Pat. No. 9,067,541, by named inventors Sobecki et. al., entitled, “Exterior mirror assembly with actuator” (“Sobecki '541”) both teach an external rearview mirror with two motors driving one worm shaft that communicates to a second worm shaft connected to worm wheel, allowing the mirror to rotate the reflecting surface both horizontally and vertically.

U.S. Utility Pat. No. 8,127,641, by named inventors Tilg, et. al., entitled, “Device to adjust the orientation of a mirror of a motorcar” (“Tilg '641”) teaches an external rearview mirror with two worms, two gears, and two motors designed to be assembled with a tight fit. Tilg '641 further discloses the use of spring clutch to disengage the gear assembly during periods of heavy load.

U.S. Utility Pat. No. 5,990,649, by named inventors Nagao et. al., entitled, “Control device for quick angle adjustment of rearview mirror” (“Nagao '649”) teaches a variation of an external rearview mirror using two motors and two worm gears with a quick adjust feature.

U.S. Utility Pat. No. 5,838,507, by named inventors Boddy et. al., entitled, “Mirror assembly with friction drive” (“Boddy '507”) teaches using two electric motors, a worm, a worm pinion, and a spiral gear to move a mirror face (claim 10).

U.S. Utility Pat. No. 4,824,232, by named inventor Thompson, entitled, “Drive system with resilient yieldable biased actuator shaft for electric rear view mirror” (“Thompson '232”) teaches using two worms, two pinions, two electric motors, and an actuator with hair-pin engagement clip to adjust a mirror.

U.S. Utility Pat. No. 4,815,837, by named inventors Kikuchi et. al., entitled, “Actuator unit housing for rearview mirror” (“Kikuchi '837”) teaches using two worm gears and worm wheels to move an exterior rearview, through the use of harnesses. The actuator unit housing for a rearview mirror includes two electric motors for tilting a mirror element in an actuator unit, and a drive transmission, and means for foldably supporting a mirror element on the upper surface of the actuator housing.

The prior art teaches using multiple motor and gear assemblies to move a mirror. The prior art does not adequately teach using multiple motor and gear assemblies to provide a mechanism capable of auto-adjusting a mirror, nor does the prior art adequately teach using dc brushless motors (“BLDC”) to perform this task.

### SUMMARY OF THE INVENTION

This summary is intended to disclose the present invention, an auto-adjustable display mount. The embodiments and descriptions are used to illustrate the invention and its utility, and are not intended to limit the invention or its use.

The present invention relates to using two worm gear assemblies and two BLDC in order to auto-adjust a display, such as an internal rearview mirror in a vehicle. The auto-adjustable display mount is comprised of two adjustment modules, an electrical connection, a bracket with which to attach to a display, and a control means. Each adjustment module is comprised of a housing; a BLDC; a worm extending from the BLDC; a mating gear for the worm; and a rotational axle, connected to, and coaxial with, the mating gear. The two modules are powered by the single connector on the upper module. The power and control signals are routed from the first module to the second module. The rotational axle for the first module is fastened to the second module, so that the end of the rotational axle of the first module, which is fastened to the second module, is fixed with respect to the second module. The rotational axle for the second module is fixed with respect to the display bracket. The auto-adjustable display mount has an adjustment means attached to it through the electrical connector. The BLDC and axle of the upper adjustment module and the BLDC and axle of the lower adjustment module operate independently. Independent operation of the axles allows for independent control of the two spherical angles.

A BLDC has many advantages over the electric motors typically used in vehicle mirror applications. A BLDC is quieter, lighter, and smaller. A BLDC can be easily integrated into the diagnostics of a vehicle. A BLDC has lower emissions from an electro-magnetic compatibility point of view. A BLDC does not generate dust, does not spark, and lasts longer, generally being a more robust in-vehicle design.

A BLDC has a rotor and stator, just like a traditional DC motor. However, in a BLDC, permanent magnets are mounted on the rotor, and the stator is wound with a specific number of poles. An integrated inverter and switching circuit is used to achieve unidirectional torque. Windings of the stator are energized in succession in order to make the rotor spin.

The auto-adjustable display mount can be rotated through 120° in each of two spherical coordinates. This allows the auto-adjustable display mount to be rotated into an ideal position regardless of driver, use position, and external conditions. The auto-adjustable display mount has a control means comprised of a control circuit and software, that dictates the positioning of the auto-adjustable display mount, depending on the identity of the driver, the driver's use position, and the external conditions.

### BRIEF DESCRIPTION OF THE DRAWINGS

The present invention is illustrated with 9 figures on 6 sheets.

FIG. 1 is a top view of the auto-adjustable display mount with a display attached. FIG. 2 is an isometric view of the auto-adjustable display mount with a display attached. FIG. 3 is a front view of a display attached to the auto-adjustable display mount. FIG. 4 is a side view of the auto-adjustable display mount with a display attached.

FIG. 5 is a top view of the auto-adjustable display mount with an internal rearview mirror attached. FIG. 6 is a front view of the auto-adjustable display mount with an internal rearview mirror attached. FIG. 7 is a side view of the auto-adjustable display mount with an internal rearview mirror attached.

FIG. 8 is an isometric rearview of the auto-adjustable display mount with an internal rearview mirror attached, with the internal components of each module visible. FIG. 8A is an isolation isometric view of the internal components of each module.

FIG. 9 is an exploded isometric view of a BLDC.

### DETAILED DESCRIPTION OF THE DRAWINGS

The following descriptions are not meant to limit the invention, but rather to add to the summary of invention, and illustrate the present invention, by offering and illustrating various embodiments of the present invention, an auto-adjustable display mount. While embodiments of the invention are illustrated and described, the embodiments herein do not represent all possible forms of the invention. Rather, the descriptions, illustrations, and embodiments are intended to teach and inform without limiting the scope of the invention.

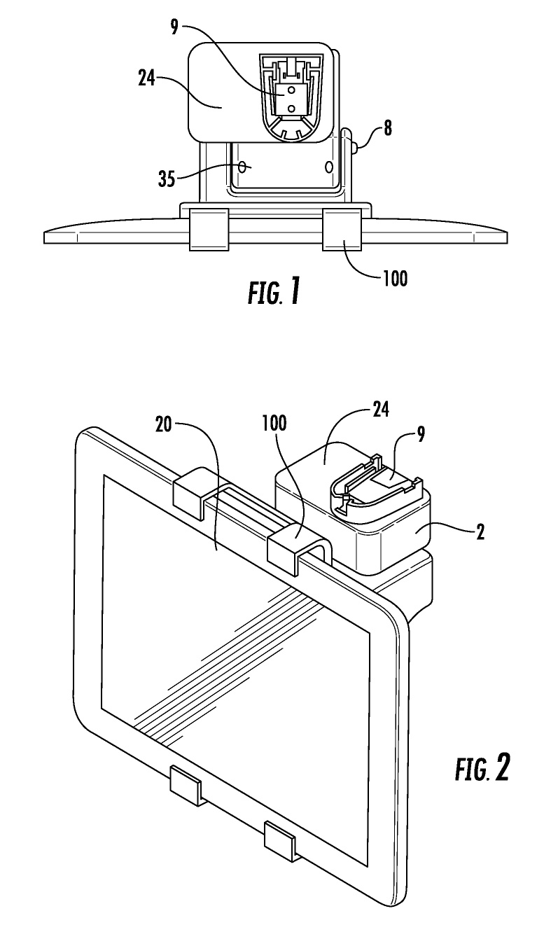

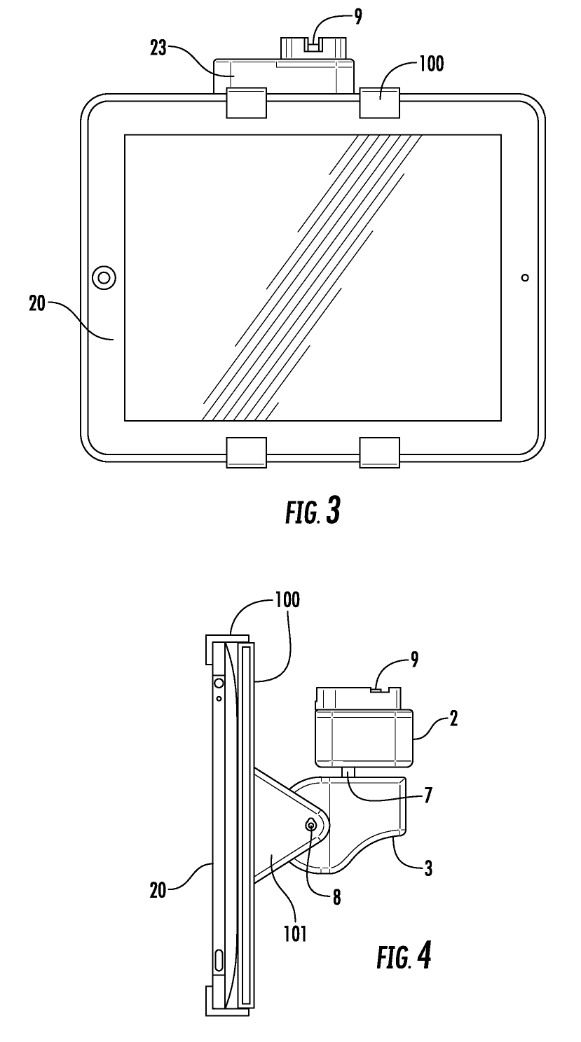

FIGS. 1-4 show the present invention, an auto-adjustable display mount, with a tablet computer mounted thereto. The auto-adjustable display mount has an upper module 2 and a lower module 3. The upper module 2 and lower module 3 are connected with a rotational axis 7. The lower module 3 is connected to a display 20 bracket 100 about an axle with a fastener 8 through a bracket 100 mount 101. A hook fastener 9 on the top surface 24 of the upper module 2 mounts the present invention to the windshield or other suitable surface.

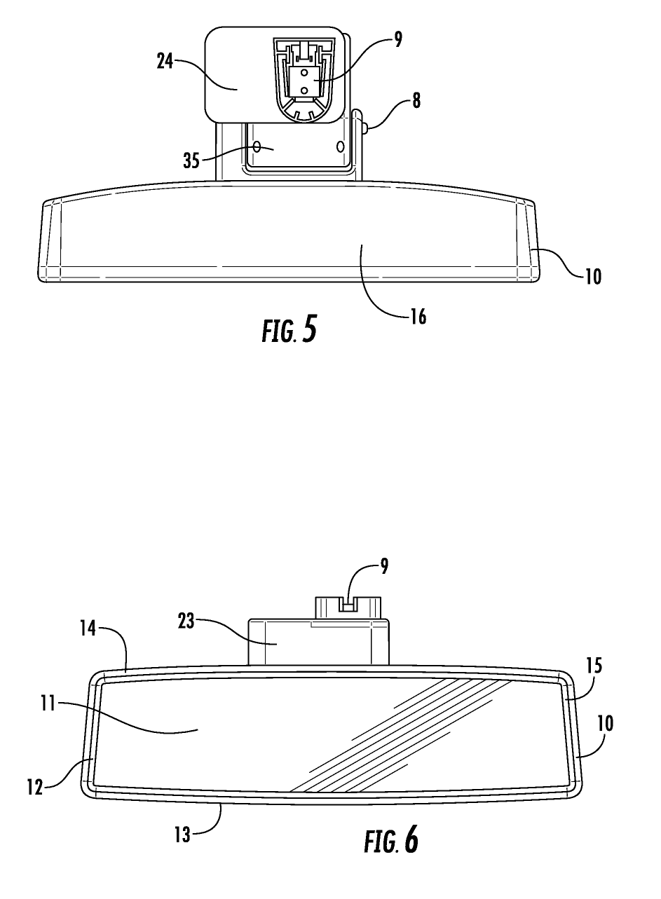

FIGS. 5-8 show the present invention, an auto-adjustable display mount 1, with an internal rearview mirror attached. The auto-adjustable display mount 1 has an upper module 2 and lower module 3. The upper module 2 has a top surface 24, two opposed large and substantially rectangular side surfaces 23 and two opposed small and substantially rectangular side surfaces 22. As shown, the lower module 3 has two opposed side surfaces 32 and a top surface 36 that are visible. The side surface 32 of the lower module 3 has an ear 58 to engage with the bracket 35. The ear 58 has a rounded edge 51. The internal rearview mirror has a reflective surface 11, a case 10, and a bracket 35. The bracket 35 has a top surface 35 and two opposing side surfaces 50, and is connected to the lower module 3 about an axle with a fastener 8. The case 10 is made up of two short, opposing side surfaces 17, two opposing long surfaces 16, and a rear surface 18. The case 10 retains the mirror on four sides with a rim 12, 13, 14, 15.

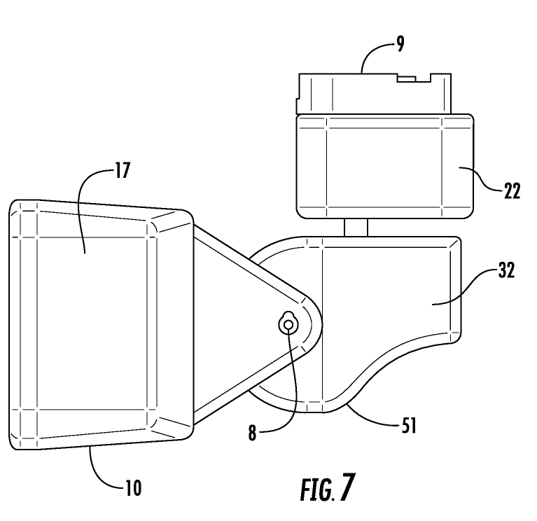

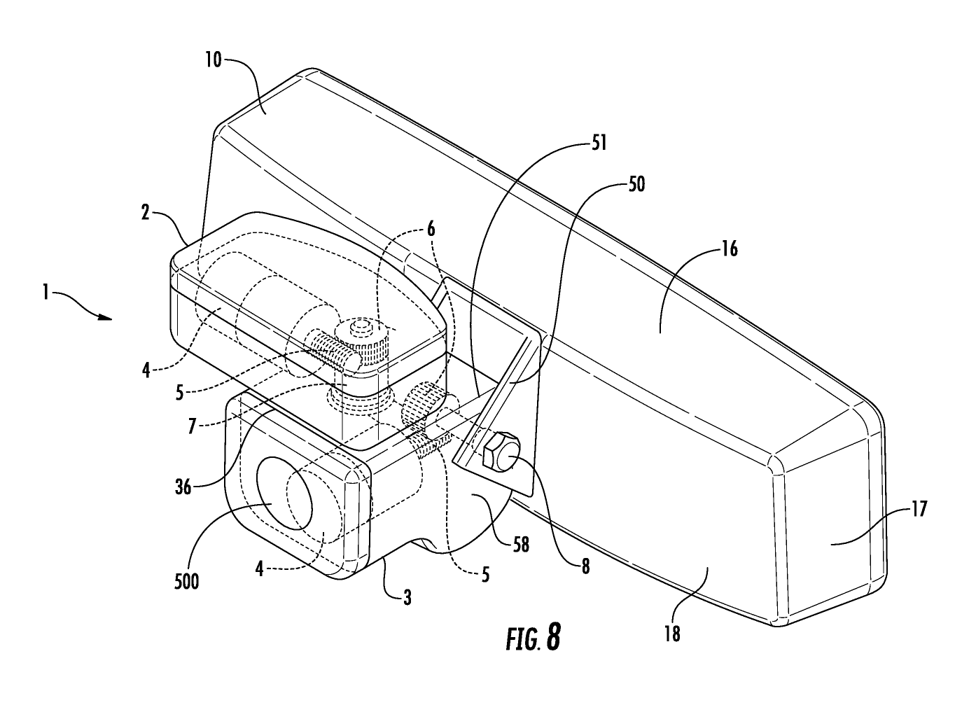

Looking at FIGS. 8 and 8A, internal to the upper module 2 and lower module 3 are a BLDC 4; and a worm gear 5, 6 consisting of a toothed wheel 6 worked by a short revolving cylinder (worm) 5. The toothed wheel 6 of the upper module 2 is coaxially connected to a vertical rotational axle 7. The toothed wheel of the lower module 3 is coaxially connected to an axle 19 that passes through the bracket 35 and terminates in the fastener 8. The vertical rotational axle 7 is orthogonal to the rotational axle 19. The rotational axis of the vertical rotational axle 7 does not intersect the axle 19. The rotational axis of the rotational axle 19 does not intersect the vertical axle 7. The upper adjustment module 2 drives its axle of rotation 7 independently of the axis of rotation 19 of the lower adjustment module 3. Optionally, the lower module can have a photo-detector 500, in order to adjust an electro-chromatic mirror.

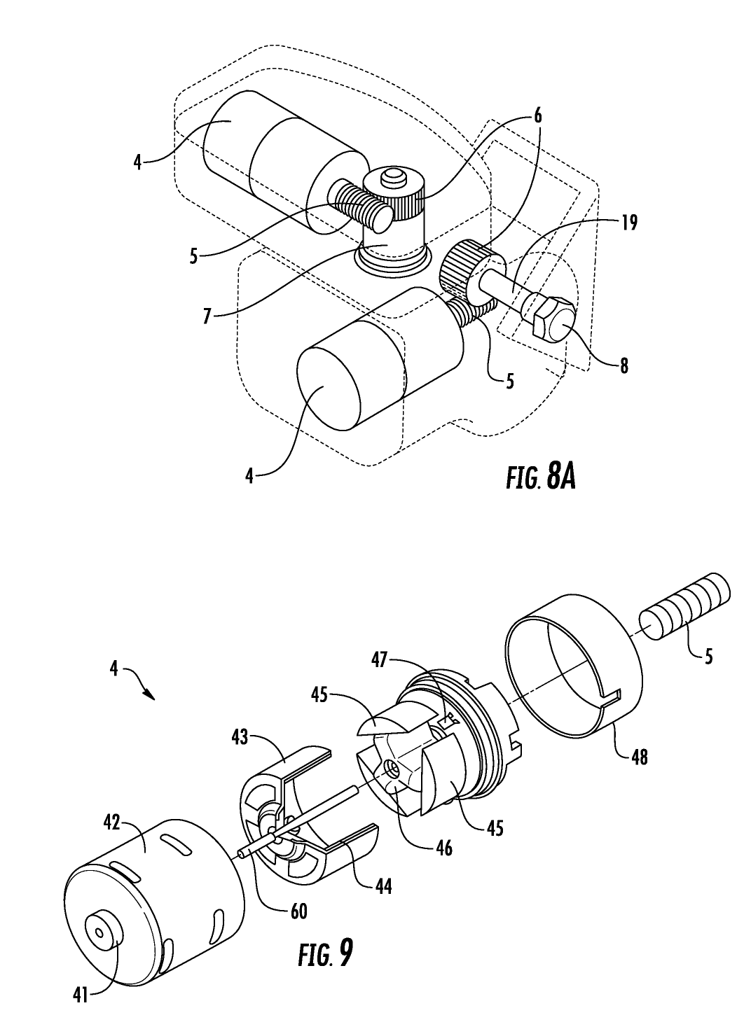

FIG. 9 shows an exploded view of the BLDC 4. A BLDC has a stator 45 made up of a plurality of windings 45, and a rotor 43 made up of a permanent magnet 44. The permanent magnet 44 of the rotor 43 rotates. The BLDC has an integrated circuit housing containing an integrated inverter and switching circuit 46 and a hall sensor 47. An output shaft 60 is fastened to the rotor 43. One end of the output shaft 60 terminates in a bearing 41. The other end of the output shaft 60 is coaxial with, and fastened to, a short revolving cylinder (worm) 5. The BLDC has an upper 42 and lower 48 housing. The short revolving cylinder (worm) 5 rotates at the same speed as the rotor 43. The rotor 43 of the BLDC 4 rotates in response to direct current pulses being sent, sequentially, to the plurality of windings 45. The integrated inverter and switching circuit 46 controls the pulsing of the stator windings 45. The hall sensor 47 helps the integrated inverter and switching circuit 46 determine which of the stator windings 45 should be energized, by sensing the magnetic field of the rotor 43 magnet 44.

The present invention 1 can rotate each axle 7, 19 through a 120° angle, in spherical coordinates. A control signal means sends a control signal through an electrical connector. This controls the motion of the upper module 2 and the lower module 3 by controlling the rotation of the BLDC 4 within each module 2, 3. The present invention 1 can be used in several different applications, by being mated to a tablet computer 20, an internal rearview mirror 11, or any other type of small display. The control means can send signals to adjust the present invention 1 based off of the user, the user's position, environmental conditions, location of the display, or application.

The housing of the upper and lower modules can be fabricated from a wide variety of environmentally durable, structural materials, such as steel, aluminum, zinc, magnesium, poly(methyl-methacrylate) (“PMMA”), polycarbonate (“PC”), acrylonitrile butadiene styrene (“ABS”), polypropylene (“PP”), high-density polyethylene (“HDPE”), and low-density polyethylene (“LDPE”). The rotational axles of the upper and lower modules can be fabricated from a wide variety of environmentally durable, structural materials, such as steel, aluminum, zinc, magnesium, PMMA, PC, ABS, PP, HDPE, and LDPE. The worm gears of the upper and lower modules can be fabricated from a wide variety of environmentally durable, structural materials, such as steel, aluminum, zinc, magnesium, PMMA, PC, ABS, PP, HDPE, and LDPE.

We claim:

1. An auto-adjustable display mount comprising:
an upper adjustment module;
a lower adjustment module;
a single electrical connector;
a bracket with which to attach to a display;
and a control means;
wherein the upper adjustment module is comprised of a housing, a direct-current brushless motor (“BLDC”) with an output shaft; a worm gear attached to the output shaft; and a substantially vertical rotational axle attached to the worm gear;
wherein the lower adjustment module is comprised of a housing, a BLDC with an output shaft; a worm gear attached to the output shaft; and a rotational axle attached to the worm gear; and
wherein each worm gear is comprised of a short revolving cylinder (worm) that is coaxial with, and attached to, the output shaft of the BLDC; and a toothed wheel coaxial with, and attached to, the rotational axle.

2. The auto-adjustable display mount of claim 1, wherein the lower adjustment module is fixed to the end of the rotational axle of the upper adjustment module.

3. The auto-adjustable display mount of claim 2, wherein the rotational axle of the lower adjustment module is fixed to the bracket.

4. The auto-adjustable display mount of claim 3, wherein the rotational axle of the lower adjustment module and the rotational axle of the upper adjustment module are orthogonal.

5. The auto-adjustable display mount of claim 4, wherein the rotational axle of the upper adjustment module can rotate through 120°.

6. The auto-adjustable display mount of claim 5, wherein the rotational axle of the lower adjustment module can rotate through 120 °.

7. The auto-adjustable display mount of claim 1, wherein the electrical connector is on the top surface of the upper adjustment module.

8. The auto-adjustable display mount of claim 7, wherein the upper adjustment module is electrically connected with the lower adjustment module.

9. The auto-adjustable display mount of claim 1, wherein the BLDC is comprised of a stator having of a plurality of windings; a rotor having a permanent magnet; an integrated inverter and switching circuit capable of sequentially delivering pulses of direct current electricity to the plurality of stator windings; a hall sensor capable of determining the current position of the permanent magnet; an output shaft; a bearing; and a housing.

10. The auto-adjustable display mount of claim 9, wherein the permanent magnet of the rotor cylindrically surrounds the plurality of stator windings.

11. The auto-adjustable display mount of claim 9, wherein the permanent magnet of the rotor is surrounded by the plurality of stator coils.

12. The auto-adjustable display mount of claim 1, wherein the housing of upper adjustment module is fabricated from at least one of steel, aluminum, zinc, magnesium, poly(methyl-methacrylate) (“PMMA”), polycarbonate (“PC”), acrylonitrile butadiene styrene (“ABS”), polypropylene (“PP”), high-density polyethylene (“HDPE”), and low-density polyethylene (“LDPE”).

13. The auto-adjustable display mount of claim 1, wherein the housing of the lower adjustment module is fabricated from at least one of steel, aluminum, zinc, magnesium, PMMA, PC, ABS, PP, HDPE, and LDPE.

14. The auto-adjustable display mount of claim 1, wherein the rotational axle of the upper adjustment module is fabricated from at least one of steel, aluminum, zinc, magnesium, PMMA, PC, ABS, PP, HDPE, and LDPE.

15. The auto-adjustable display mount of claim 1, wherein the rotational axle of the lower adjustment module is fabricated from at least one of steel, aluminum, zinc, magnesium, PMMA, PC, ABS, PP, HDPE, and LDPE.

16. The auto-adjustable display mount of claim 1, wherein the worm gear of the upper adjustment module is fabricated from at least one of steel, aluminum, zinc, magnesium, PMMA, PC, ABS, PP, HDPE, and LDPE.

17. The auto-adjustable display mount of claim 1, wherein the worm gear of the lower adjustment module is fabricated from at least one of steel, aluminum, zinc, magnesium, PMMA, PC, ABS, PP, HDPE, and LDPE.

18. The auto-adjustable display mount of claim 1, wherein the control means can energize the BLDC of the upper adjustment module.

19. The auto-adjustable display mount of claim 18, wherein the control means can energize the BLDC of the lower adjustment module.

20. The auto-adjustable display mount of claim 19, wherein the control means can energize the BLDC of the lower adjustment module independently from the BLDC of the upper adjustment module.

21. The auto-adjustable display mount of claim 20, wherein the control means can adjust the position of the bracket with which to attach the display based on at least one of the identify of a user, the position of the user, the environmental conditions, the location of the display, or the type of display.
